(19) United States
(12) Patent Application Publication
(10) Pub. No.: US 2014/0068598 A1
(43) Pub. Date: Mar. 6, 2014

(54) INFORMATION PROCESSING APPARATUS, INFORMATION PROCESSING METHOD, AND PROGRAM

(71) Applicant: SONY CORPORATION, Tokyo (JP)

(72) Inventors: Satoshi OTSUKA, Kanagawa (JP); Masato NOGUCHI, Tokyo (JP); Atsuhiro YAMAOKA, Kanagawa (JP); Eiichi YAMADA, Tokyo (JP)

(73) Assignee: SONY CORPORATION, Tokyo (JP)

(21) Appl. No.: 13/953,200

(22) Filed: Jul. 29, 2013

(30) Foreign Application Priority Data
Aug. 30, 2012 (JP) 2012190200

(51) Int. Cl. G06F 9/445

(52) U.S. Cl. CPC G06F 8/61
USPC 717/177

(57) ABSTRACT

An information processing apparatus includes a communication unit, a storage unit, and a controller. The communication unit is configured to be able to download arbitrary application data from a service on a network in which first application data encoded by a predetermined system and second application data encoded by another system or unencoded. The storage unit is configured to store decoding information for decoding the first application data. The controller is configured to be able to decode the first application data using the decoding information to install a first application obtained by decoding the first application data.

### BACKGROUND

The present disclosure relates to an information processing apparatus, an information processing method for the information processing apparatus, and a program that are able to download and install an application to execute the application.

In related art, there is a system selectively downloading and installing an application into an information processing apparatus.

Japanese Patent Application Laid-open No. 2005-141454 (hereinafter, referred to as Patent Document 1) describes that, when a user terminal downloads a program file from a server and installs the program file, specific information of the user terminal is described in the program file, and, after that, when the program file is installed into another terminal, the other terminal compares specific information of the other terminal with the described specific information, and allows installing when the both correspond to each other.

Japanese Patent Application Laid-open No. 2011-044147 (hereinafter, referred to as Patent Document 2) describes that a user terminal transfers user terminal information to a server, receives an application list generated by the server based on the user terminal information, and displays the application list on a screen, and the user selects an application to be executed from the application list.

Japanese Patent Application Laid-open No. 2003-223235 (hereinafter, referred to as Patent Document 3) describes that, using information for application authentication retained in a tampering resistant range of an authentication module, a terminal carries out authentication of the application downloaded to the terminal, to thereby checks the place of origin and the presence or absence of tampering.

### SUMMARY

However, in the technique described in the Patent Document 1, whether or not the program file can be installed is determined by comparison of the specific information of the user terminal. Therefore, it is necessary to add the specific information to the user terminal.

Further, in the technique described in the Patent Document 2, the application list that can be installed is displayed by transferring the information of the user terminal to the server. A new mechanism for transferring the terminal information to the user terminal becomes necessary. Further, the server needs a new mechanism for generating the application list.

Further, in the technique described in the Patent Document 3, whether or not it is an illegal application is determined by an authentication function of the terminal. Thus, this new authentication function is necessary for the terminal.

In the above-mentioned circumstances, it is desirable to provide an information processing apparatus, an information processing method, and a program that are able to reliably install only an application to be installed without changing an existing framework of application download services.

According to an embodiment of the present disclosure, there is provided an information processing apparatus including a communication unit, a storage unit, and a controller. The communication unit is configured to be able to download arbitrary application data from a service on a network in which first application data encoded by a predetermined system and second application data encoded by another system or unencoded are both provided. The storage unit is configured to store decoding information for decoding the first application data. The controller is configured to be able to decode the first application data using the decoding information to install a first application obtained by decoding the first application data.

With this configuration, the information processing apparatus is able to decode the application data encoded by the predetermined system. Thus, without changing an existing framework of application download services, only an application to be installed can be reliably installed.

The first application data may include a file name including a predetermined extension, and the storage unit may be configured to store extension information indicating the predetermined extension. In this manner, the controller may be configured to compare the extension information with an extension of the downloaded application data before the decoding to determine whether or not the application data can be installed.

With this, the information processing apparatus is able to determine the application data that cannot be installed without decoding processing. Thus, a time taken for determining whether or not the application data can be installed can be reduced.

The first application data may include a first section encrypted by a first encryption system, and a second section encrypted by a second encryption system different from the first encryption system or unencrypted. In this case, the storage unit is configured to store, as the decoding information, a first decryption key corresponding to the first encryption system and a second decryption key corresponding to the second encryption system. Further, in this case, the controller is configured to be able to decrypt the encrypted first section with the first decryption key, and to decrypt the encrypted second section with the second decryption key. Here, the second encryption system has strength lower than strength of the first encryption system.

With this, the first application data is encrypted at a different strength for each section. Thus, the information processing apparatus is able to reduce the time taken for the decoding processing in comparison with the case where all sections of the first application data are encrypted by the first encryption system.

The first section may be a program area, and the second section may be a resource area.

With this, a resource area having a large amount of information in the application data is encrypted at low strength or unencrypted. Thus, the time taken for the decoding processing of the application data can be further reduced.

The first application data may include an additional data area in which structure information indicating a structure of the first section and a structure of the second section is described. In this case, the controller may be configured to be able to decrypt the first section and the second section based on the structure information.

With this, the information processing apparatus is able to decode application data having any structure that has been encrypted by the encryption systems having different strengths for each section.

The first application data may include an additional data area in which specification information indicating a specification of the first application data is described. In this case, the controller may be configured to be able to determine whether or not the first application data can be installed based on the specification information described in the additional data area before the decoding.

With this, the information processing apparatus is able to determine the application data that cannot be installed because the specification thereof is not supported, without the decoding processing. Thus, the time taken for determining whether or not the application data can be installed can be reduced.

The first application data may be obtained by encoding application data in different versions depending on a specification of the information processing apparatus into single data, and include an additional data area in which specification information is described, the specification information indicating a relationship between the specification of the information processing apparatus and a version of application data that can be installed. In this case, the controller may be configured to be able to select, before the decoding, based on the specification information described in the additional data area, application data to be installed from the application data in different versions.

With this, the information processing apparatus is able to install the application data according to the specification thereof without downloading the application data different for each specification.

The first application data may include an additional data area in which determination information for determining whether or not the first application data is correctly decoded is described. In this case, the controller may be configured to be able to determine, after the decoding of the first application data and before the installation, based on the determination information described in the additional data area, whether or not the first application data is correctly decoded.

With this, the information processing apparatus is able to check whether or not the first application data has been correctly decoded before the installation, which can prevent install failure.

The first application data may be encrypted with a predetermined encryption key and a unique code that depends on one of a kind and a specification of the information processing apparatus. In this case, the storage unit may be configured to store the encryption key and the unique code that depends on the one of the kind and the specification of the information processing apparatus. Further, in this case, the controller may be configured to be able to decode the first application data using the stored encryption key and unique code.

With this, the information processing apparatus uses the unique code that depends on the one of the kind and the specification of the information processing apparatus together with the encryption key to decode the first application data. In this manner, even if the encryption key is leaked to an outside, it is possible to prevent the first application data from being illegally installed into an information processing apparatus having a different specification or a different kind of information processing apparatus.

The information processing apparatus may be an apparatus other than a smart phone. Specifically, the information processing apparatus may be a camera.

With this, the information processing apparatus is able to download and install application data to be installed out of application data that can be provided also to a smart phone, utilizing the same framework as the smart phone.

According to another embodiment of the present disclosure, there is provided an information processing method including downloading, from a service on a network in which first application data encoded by a predetermined system and second application data encoded by another system or unencoded are both provided, the first application data. Further, the method includes decoding the first application data using decoding information for decoding the first application data, and installing a first application obtained by decoding the first application data.

According to still another embodiment of the present disclosure, there is provided a program that causes an information processing apparatus to execute a download step, a decoding step, and an installation step. In the download step, from a service on a network in which first application data encoded by a predetermined system and second application data encoded by another system or unencoded are both provided, the first application data is downloaded. In the decoding step, the first application data is decoded using decoding information for decoding the first application data. In the installation step, a first application obtained by decoding the first application data is installed.

As mentioned above, according to the embodiments of the present disclosure, it is possible to reliably install only an application to be installed without changing an existing framework of application download services.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a view showing a network configuration of a system according to a first embodiment of the present disclosure;

FIG. 2 is a block diagram showing a hardware configuration of a CE device in the system;

FIG. 3 is a view explaining an encryption system for application data to be downloaded from a server in the system;

FIG. 4 is a view showing a file format of the application data;

FIG. 5 is a flowchart showing a flow of install processing of the application data by the CE device;

FIG. 6 is a flowchart showing a flow of install processing of application data by a CE device according to a second embodiment of the present disclosure;

FIG. 7 is a view showing a file format of application data according to a third embodiment of the present disclosure;

FIG. 8 is a flowchart showing a flow of decoding processing of the application data by the CE device according to the third embodiment;

FIG. 9 is a view showing a file format of application data according to a fourth embodiment of the present disclosure;

FIG. 10 is a flowchart showing a flow of decoding processing of application data by a CE device according to the fourth embodiment;

FIG. 11 is a view showing a file format of application data according to a fifth embodiment of the present disclosure;

FIG. 12 is a flowchart showing a flow of decoding processing of application data by a CE device according to the fifth embodiment;

FIG. 13 is a view showing a file format of application data according to a sixth embodiment of the present disclosure;

FIG. 14 is a flowchart showing a flow of decoding processing of application data by a CE device according to the sixth embodiment;

FIG. 15 is a view explaining an encryption system for application data to be downloaded from a server according to a seventh embodiment of the present disclosure;

FIG. 16 is a view explaining an application example of a unique code according to the seventh embodiment;

FIG. 17 is a view explaining the application example of the unique code according to the seventh embodiment; and

FIG. 18 is a flowchart showing a flow of the decoding processing of the application data by a CE device according to the seventh embodiment.

### DETAILED DESCRIPTION OF EMBODIMENTS

Hereinafter, embodiments of the present disclosure will be described with reference to the drawings.

### First Embodiment

First, a first embodiment of the present disclosure will be described.

### [Network Configuration of System]

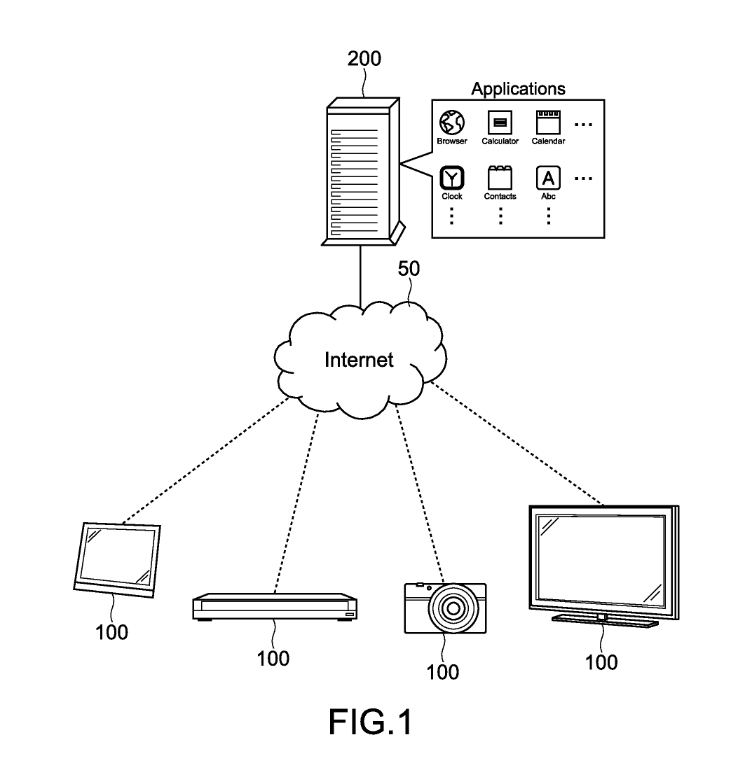

FIG. 1 is a view showing a network configuration of a system according to this embodiment.

As shown in the figure, in this system, various consumer electronics (CE) devices 100 and a server 200 are connected via the Internet 50.

The CE device can be any information processing apparatus other than a smart phone, for example, a TV, a digital still camera, a digital video camera, a Blu-ray Disc (BD)/digital versatile disk (DVD) player, a BD/DVD recorder, a digital photo frame, a game console, a car navigation apparatus, or an Audio/video (AV) device.

The server 200 stores multiple application data items. The server 200 provides a download service (application store) for those application data items to the CE devices 100. For example, the application data is application data for Android (registered trademark). The various CE devices 100 each incorporate Android (registered trademark) as an OS.

The application data items provided by the server 200 in the application store includes those encrypted in a predetermined system to be described later, and those encrypted in another system or unencrypted.

### [Hardware Configuration of CE Device]

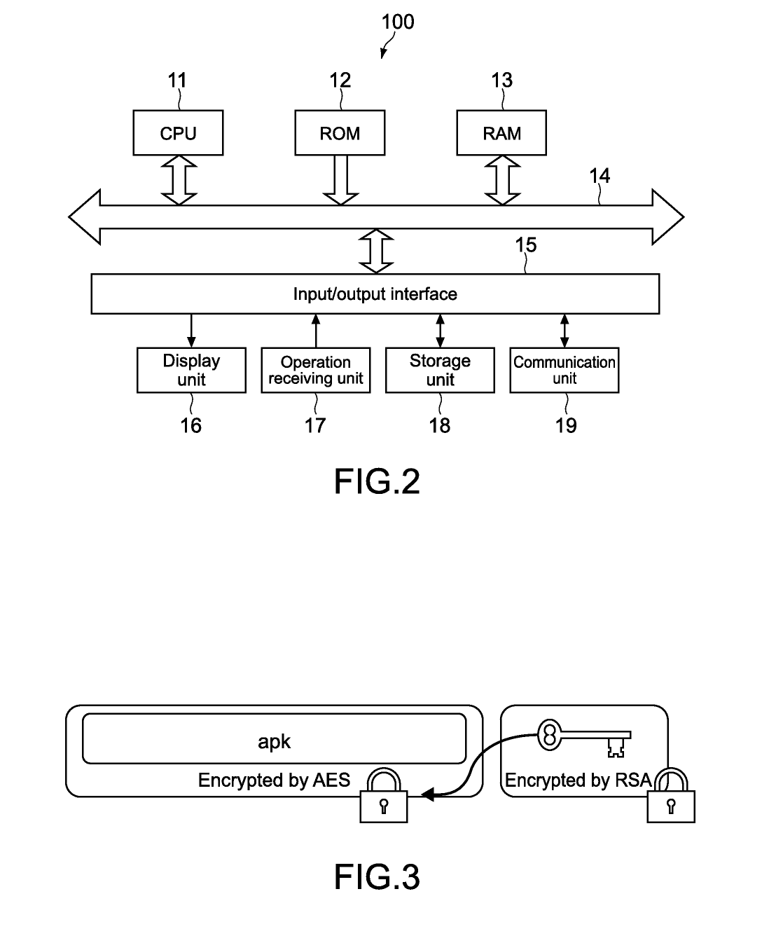

FIG. 2 is a view showing a hardware configuration of one of the CE devices 100. As shown in the figure, the CE device 100 includes a central processing unit (CPU) 11, a read only memory (ROM) 12, a random access memory (RAM) 13, an input/output interface 15, and a bus 14 that connects them to one another.

The CPU 11 appropriately accesses the RAM 13 and the like depending on needs, and performs overall control on all the blocks of the CE device 100 while performing various types of arithmetic processing. In this embodiment, for example, the CPU 11 executes download processing, decoding processing, or install processing for application data from the server 200.

The ROM 12 is a non-volatile memory in which an OS and firmware such as various programs and parameters to be executed by the CPU 11 are fixedly stored. The RAM 13 is used as a working area for the CPU 11, and temporarily held in the OS, the various applications being executed, and various types of data being processed.

A display unit 16, an operation receiving unit 17, a storage unit 18, a communication unit 19, and the like are connected to the input/output interface 15.

For example, the display unit 16 is a display device using a liquid crystal display (LCD), an organic electro luminescence display (OELD), a cathode ray tube (CRT), or the like. A certain CE device 100 does not incorporate the display unit 16 and is connected to an external display apparatus.

For example, the operation receiving unit 17 is a pointing device such as a mouse, a keyboard, a button, a touch panel, or another input apparatus. If the operation receiving unit 17 is a touch panel, the touch panel may be integrated with the display unit 16.

For example, the storage unit 18 is a non-volatile memory such as a hard disk drive (HDD), a flash memory (solid-state drive (SSD)), and another solid-state memory. The storage unit 18 stores the OS, the various applications, and the various types of data. In particular, in this embodiment, the storage unit 18 stores a plurality of applications downloaded and installed from the server 200. Further, the storage unit 18 also stores software (downloader) for downloading the application data encrypted from the server 200, software (unpackager) for decoding the downloaded software, and software (installer) for installing the application data.

The communication unit 19 is a wireless communication module for connecting to a wireless LAN, a 3G network, or the like, a network interface card (NIC) for connecting to the Internet 50, or the like. The communication unit 19 serves to perform communication processing with the server 200.

### [Encryption System for Application Data]

FIG. 3 is a view showing, out of the application data provided by the server 200, an encryption system for application data that can be installed to the CE device 100.

As shown in the figure, the application data is encrypted by, for example, an advanced encryption standard (AES) encryption system and a Rivest Shamir Adleman (RSA) encryption system.

Specifically, first, an original application data file (e.g., apk file provided to Android (registered trademark) terminal in related art) is, for example, encrypted by an AES system. In addition, a common key used in the AES encryption is encrypted with a secret key of the RSA and packaged together with data encrypted by the AES. In this embodiment, encryption (encoding) processing of the application data is also referred to as “packaging.” Further, decryption processing of the encrypted application data by the unpackager is also referred to as “unpackaging.”

A public key corresponding to the secret key of the RSA is stored in the CE device 100 in advance. The CE device 100 includes a module for executing encryption and decryption processing of the RSA and the AES.

The packaged application data file includes, for example, an extension “pkg.” The packaged application data file includes, as part of a file name thereof, information indicating a format version thereof. Specifically, the file name of the application data file is, for example, in a form of “(arbitrary name).(format version).pkg.”

For example, if the application data has a file name of “MyApp.1.pkg,” “1” indicates a version thereof. Although will be described later, the extension and the version information are referred to in pre-processing of the decryption processing by the CE device 100.

### [File Format of Application Data]

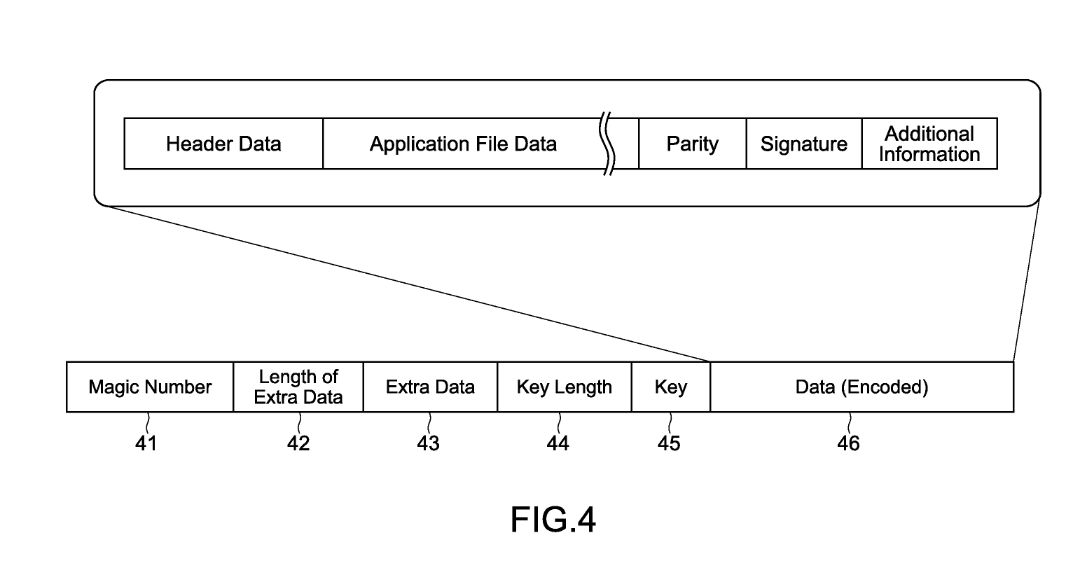

FIG. 4 is a view showing a file format of the application data shown in FIG. 3.

As shown in the figure, the application data includes a magic number area 41, a length-of-extra-data (additional-data) area 42, an extra data (additional data) area 43, a key length area 44, a key area 45, and a data area 46.

Out of those areas, only the data area 46 is encrypted by the system shown in the FIG. 3.

The magic number area 41 is set to be an arbitrary numeral by a developer of the application data.

The additional data area 43 is an area that can be freely used by the developer of the application data. In the additional data area 43, for example, information of a developer company name, a product name, a model number and a category of a product, and the like are described. The length-of-additional-data area 42 is an area defining a data length of the additional data area 43.

In the key area 45, the common key of the AES encrypted with the secret key of the RSA of the application data shown in the FIG. 3 is described. The key length area 44 is an area defining a data length of the key area 45.

The data area 46 includes a header area, an application file data area, a parity area, an electronic signature area, an additional information area, and the like. The structure of the data area 46 is an example of the data structure used in an application or the like provided for Android (registered trademark). However, various structures may be employed depending on a platform of the CE device 100.

### [Operation of System]

Next, an operation of the CE device 100 in the system thus configured will be described. In this embodiment and other embodiments, the operation in the CE device 100 is performed in cooperation with the CPU 11 and software executed under control thereof (downloader, unpackager, and installer described above).

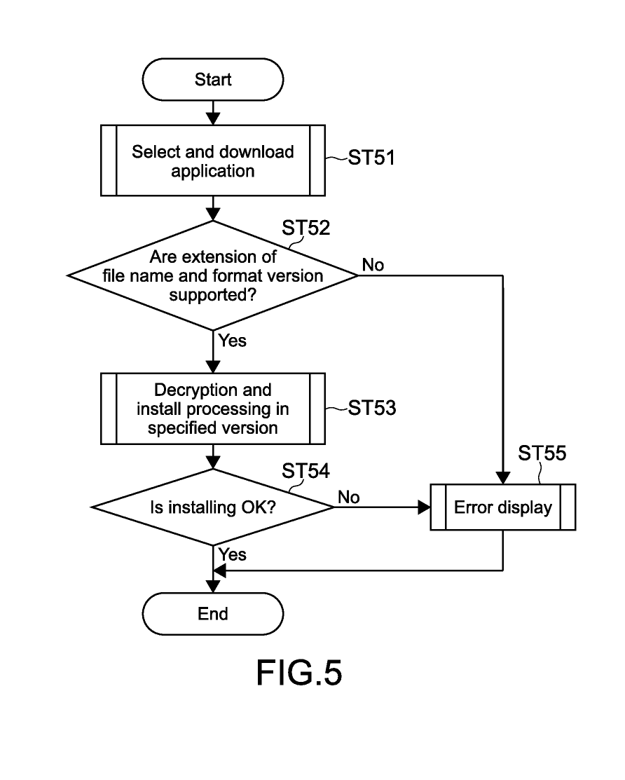

FIG. 5 is a flowchart showing a flow of install processing of the application data by the CE device 100 according to this embodiment.

As shown in the figure, first, the downloader of the CE device 100 selects, according to an operation of the user, for example, an application to be downloaded from the server 200, and downloads the application (Step 51).

Subsequently, the unpackager checks a file name of the downloaded application data, and determines whether or not the extension and the version included therein are supported by the CE device 100 (Step 52). For example, if an extension of the file is not a predetermined extension such as pkg, or if a version thereof is not a predetermined version (e.g., Version 1), the unpackager determines that the application data is not supported.

If it is determined that the extension and the version of the application data are supported (Yes), the unpackager decrypts the application data depending on the version. Then, the installer installs the decrypted application data (Step 53).

Specifically, the unpackager decrypts the key area 45 of the application data (common key of AES encrypted with secret key of RSA) with a public key of the RSA held in advance. The unpackager decrypts the data area 46 with the decrypted common key of the AES.

If the extension and the version are not supported (No in Step 52), or if the decryption processing by the unpackager and the install processing by the installer are not correctly executed (No in Step 54), the unpackager or the installer displays an error on the display unit 16 and terminates the processing (Step 55).

As described above, according to this embodiment, by determining whether or not the application data to be installed can be decrypted from the application data provided by the server 200, the CE device 100 can select the application data to be installed and reliably install the selected application data. First, by determining whether or not the application data can be installed based on the file name of the application data before the decryption processing, the CE device 100 can determine the application data that cannot be installed without the decryption processing.

### Second Embodiment

Next, a second embodiment of the present disclosure will be described. In this embodiment and the following embodiments, the same configuration and functions as those in the first embodiment are denoted by the same reference symbols, and descriptions thereof will be omitted.

In the first embodiment, whether or not the application data can be installed is determined based on the file name thereof. In this embodiment, specification information of the application data is stored in the additional data area 43 shown in the FIG. 4. An unpackager determines whether or not the application data can be installed by referring to the additional data area 43 before decryption. Here, the specification information means, for example, information indicating a device environment in which the application data is operable or the like.

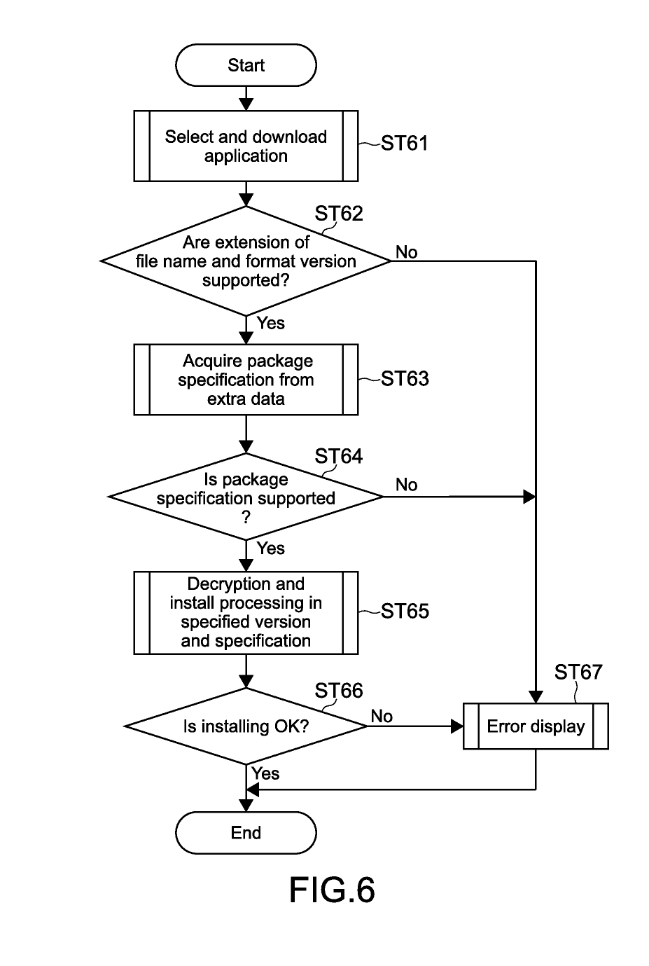

FIG. 6 is a flowchart showing a flow of install processing of application data by a CE device 100 according to this embodiment.

As shown in the figure, first, a downloader of the CE device 100 downloads the application data and determines whether or not the application data can be installed based on the file name as in FIG. 5 of the first embodiment (Steps 61 and 62).

Subsequently, the unpackager acquires specification information from the additional data area 43 (Step 63).

Subsequently, the unpackager compares the specification information with a specification of the CE device 100 (e.g., OS version, processing capability of CPU 11, storage capacities of RAM 13 and storage unit 18, network connection environment, and resolution of display unit), and determines whether or not the application data can be installed (Step 64).

If the version of the application data is supported and the specification of the CE device 100 satisfies a condition described in the specification information (Yes), the unpackager decrypts the application data according to the version and the specification. Then, an installer installs the decrypted application data (Step 65).

The subsequent processing is the same as in Steps 54 and 55 of FIG. 5 in the first embodiment (Steps 66 and 67).

As described above, according to this embodiment, by referring to the specification information described in the additional data area 43 of the application data, the CE device 100 can more reliably determine whether or not the application data can be installed before decryption.

### Third Embodiment

Next, a third embodiment of the present disclosure will be described.

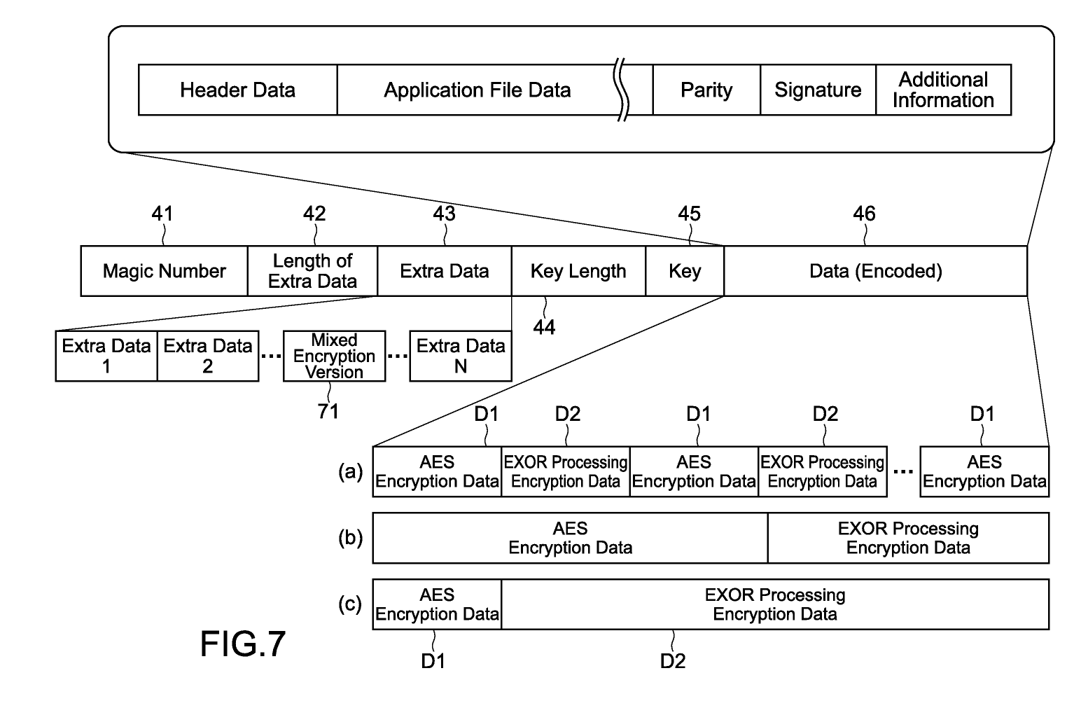

FIG. 7 is a view showing a file format of application data that can be installed into a CE device 100 according to this embodiment.

In the application data in this embodiment, a data area 46 includes a plurality of sections encrypted by encryption systems having different strengths. As shown in the figure, for example, the data area 46 includes a first section D1 encrypted by the AES and a second section D2 encrypted by the EXOR. As known, an AES encryption system has an extremely high encryption strength in comparison with the EXOR encryption system.

In this embodiment, encryption of the data area 46 by the encryption systems having different strengths is referred to as “mixed encryption processing” for a plurality of different encryption systems are mixed. As a high-strength encryption system, other than the AES, there are exemplified various encryption systems such as data encryption standard (DES), Rivest's Cipher 4 (RC4), RSA, elliptic curve cryptography (ECC), Diffie-Hellman key exchange, and CLEFIA. Further, as a low-strength encryption system, other than the EXOR, there are exemplified one-bit shift processing, reverse processing, and Endianness reverse processing (byte order conversion processing) (they may not generally be called encryption system). Further, instead of being encrypted by the encryption system low in strength, there may be an unencrypted section. Further, the encryption system of the first section D1 and the encryption system of the second section D2 may be different in system itself but the same in strength, or may be the same in system but different in strength.

Further, in the mixed encryption processing, for example, as shown in (a) to (c) of FIG. 7, depending on how the first section D1 and the second section D2 are structured, various specifications (versions) are assumed. Specifically, various mixed encryption processing versions can exist depending on data length of each section, the number of sections, encryption systems applied to the sections, and the like. Therefore, in an area of part of additional data area 43 according to this embodiment, mixed encryption version information 71 indicating a version of the mixed encryption processing is described. The CE device 100 refers to the mixed encryption version information 71, to thereby determine a decryption procedure of the data area 46 that has been subjected to the mixed encryption processing and whether or not the application data can be installed.

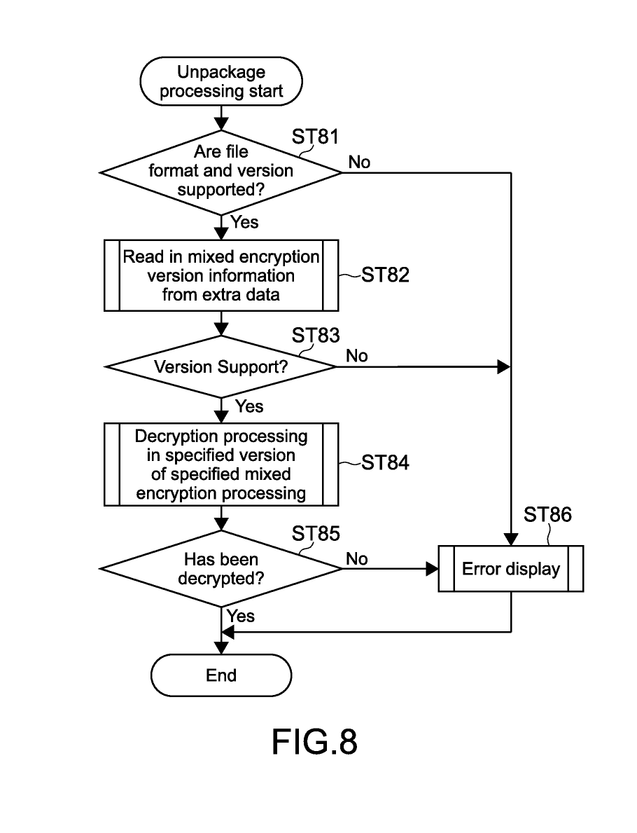

FIG. 8 is a flowchart showing a flow of decryption processing of application data by the CE device 100 according to this embodiment.

As shown in the figure, first, a downloader of the CE device 100 downloads application data as in the first and second embodiments, and an unpackager determines whether or not the application data can be installed based on a file name thereof (Step 81).

Subsequently, the unpackager reads in the mixed encryption version information 71 from the additional data area 43 (Step 82).

Subsequently, based on the mixed encryption version information 71, the unpackager determines whether or not the unpackager itself accommodates mixed-encryption decryption processing in a specified version described in the mixed encryption version information 71 (Step 83).

If the unpackager determines that the unpackager itself accommodates the mixed-encryption decryption processing in such a version (Yes), the unpackager decrypts each section of the data area 46 according to that version (Step 84).

If the unpackager determines that the unpackager itself does not accommodate the mixed-encryption decryption processing in the above-mentioned version (No) or if the unpackager has not correctly decrypted the data area 46 (No in Step 85), the unpackager displays an error on a display unit 16 and terminates the processing (Step 86).

As discussed above, according to this embodiment, the data area 46 of the application data is encrypted by the encryption systems having different strengths for each section. Therefore, the CE device 100 is able to reduce a time taken for the decryption processing in comparison with the case where all sections are encrypted by the high-strength encryption system. That is effective to the CE device 100 not having high processing capability unlike a smart phone.

### Fourth Embodiment

Next, a fourth embodiment of the present disclosure will be described.

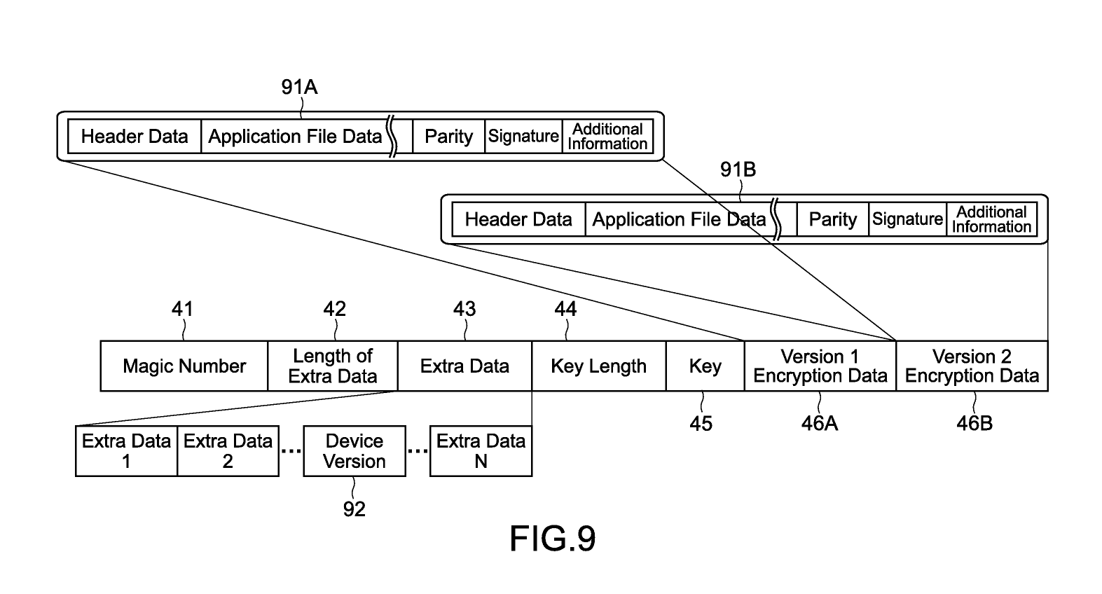

FIG. 9 is a view showing a file format of application data that can be installed into a CE device 100 according to this embodiment.

In the above-mentioned first to third embodiments, the application data provided by the server 200 has a single version of the data area 46 for each file. However, in this embodiment, as shown in the figure, application data has a plurality of data areas (e.g., two data areas 46A and 46B) corresponding to a plurality of versions (e.g., two versions).

Specifically, in this embodiment, a plurality of application data items (91A and 91B) in different versions are together encrypted and provided as a single package.

Further, in this embodiment, in part of an additional data area 43, device version information 92 indicating a version (specification) of the CE device in which the plurality of application data items in different versions are each operable is stored. The device version information 92 is, for example, series number (model number) of the same kind of devices. Further, as the device version information 92, more detailed specification information (e.g., OS version, processing capability of CPU 11, storage capacities of RAM 13 and storage unit 18, network connection environment, and resolution of display unit) may be described.

The CE device 100 refers to the device version information 92, to thereby select and install application data supported by a version thereof out of a plurality of versions of data included in the downloaded application data.

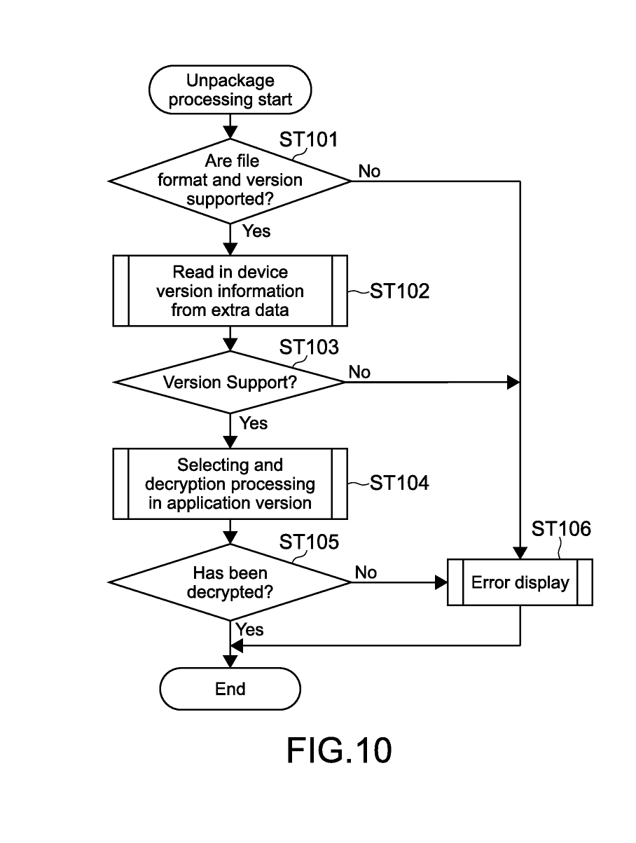

FIG. 10 is a flowchart showing a flow of decryption processing of application data by the CE device 100 according to this embodiment.

As shown in the figure, first, a downloader of the CE device 100 downloads application data as in the above-mentioned first and third embodiments, and an unpackager determines whether or not the application data can be installed based on a file name thereof (Step 101).

Subsequently, the unpackager reads in the device version information 92 from the additional data area 43 (Step 102).

Subsequently, based on the device version information 92, the unpackager determines which version out of the plurality of versions of applications included in the data areas 46A and 46B the unpackager itself accommodates (Step 103).

If the unpackager determines that the unpackager itself accommodates an application in any one of the above-mentioned versions (Yes), the unpackager selects the accommodated application and decrypts application data of the accommodated application (Step 104).

If the unpackager determines that the unpackager itself does not accommodate the application in any one of the above-mentioned versions (No) or if the unpackager has not correctly decrypted the selected application data (No in Step 105), the unpackager displays an error on a display unit 16 and terminates the processing (Step 106).

As discussed above, according to this embodiment, the plurality of versions of application data are together packaged and provided together with the device version information 92. Thus, without selecting the application data to be downloaded that corresponds to its own device version (or specification) or trying the install processing of various versions of the application data, the CE device 100 is able to install the application data corresponding to its own device version (specification) by single download processing.

### Fifth Embodiment

Next, a fifth embodiment of the present disclosure will be described.

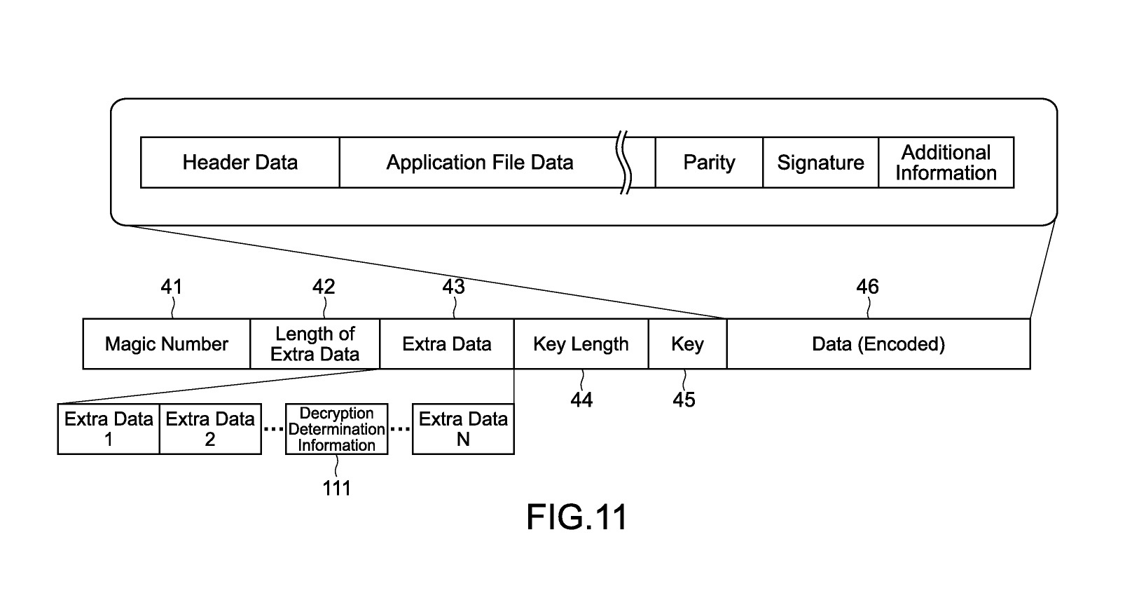

FIG. 11 is a view showing a file format of application data that can be installed into a CE device 100 according to this embodiment.

As shown in the figure, in this embodiment, in part of an additional data area 43 of application data, decryption determination information 111 for determining whether or not the application data has been correctly decrypted upon decryption of the encrypted application data is stored. As the decryption determination information, there are exemplified a data size, a cyclic redundancy check (CRC), and a hash code. Further, the decryption determination information also includes information indicating a version of an encryption system able to perform such determination.

The CE device 100 refers to the decryption determination information 111 of the downloaded application data, to thereby determine whether or not decryption of the application data has been correctly executed.

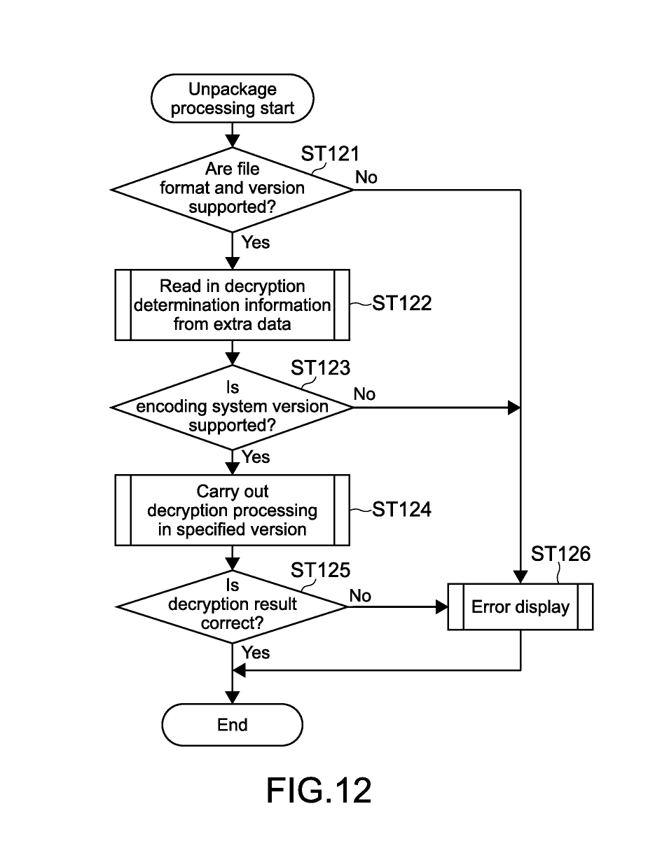

FIG. 12 is a flowchart showing a flow of decryption processing of application data by the CE device 100 according to this embodiment.

As shown in the figure, first, a downloader of the CE device 100 downloads application data as in the above-mentioned first to fourth embodiments, and an unpackager determines whether or not the application data can be installed based on a file name thereof (Step 121).

Subsequently, the unpackager reads in the decryption determination information 111 from the additional data area 43 (Step 122).

Subsequently, based on the decryption determination information 111, the unpackager determines whether or not the unpackager itself accommodates the version of the encryption system able to perform the determination processing using the decryption determination information 111 (Step 123).

When the unpackager determines that such a version of the encryption system is supported (Yes), the unpackager decrypts the downloaded application data by the system corresponding to that version (Step 124).

Subsequently, based on the decryption determination information 111, the unpackager determines whether or not the decrypted application data has been correctly decrypted (Step 124).

If the unpackager determines that the above-mentioned version of the encryption system is not supported (No in Step 123) or if the decrypted application data has not been correctly decrypted (No in Step 125), the unpackager displays an error on a display unit 16 and terminates the processing (Step 106).

As discussed above, according to this embodiment, the CE device 100 refers to the decryption determination information stored in the additional data area 43, to thereby determine whether or not the decrypted application data has been correctly decrypted.

### Sixth Embodiment

Next, a sixth embodiment of the present disclosure will be described.

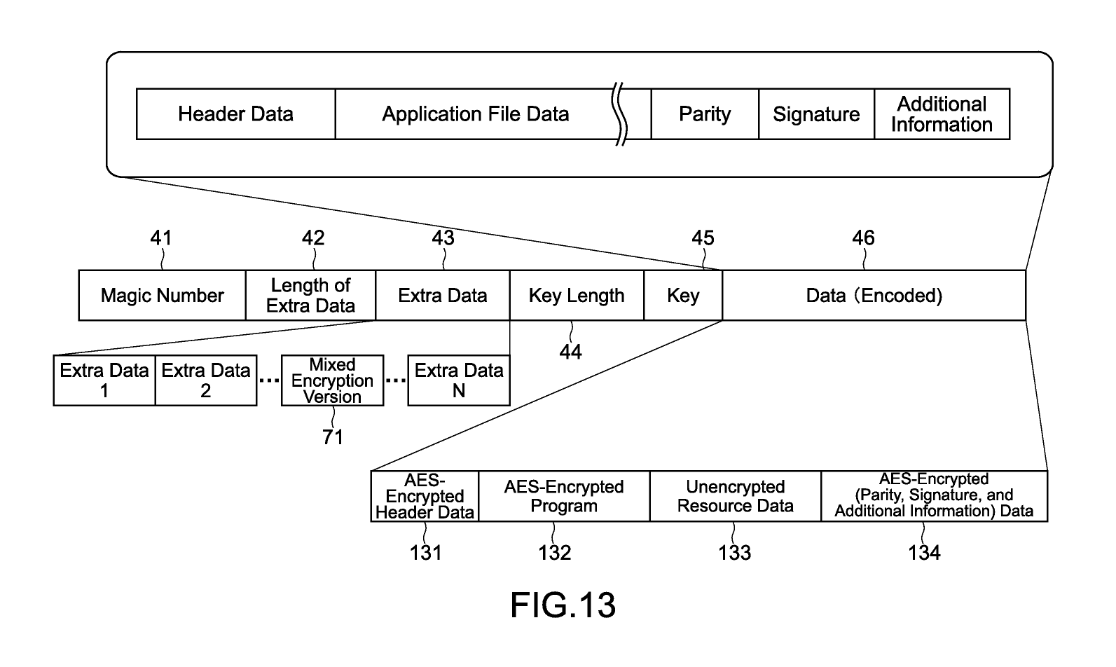

FIG. 13 is a view showing a file format of application data that can be installed into a CE device 100 according to this embodiment.

In general, a data area of the application data includes a program (substantial) area and a resource area (image data or character string data). Out of them, especially since the resource area has image data or the like, the resource area generally has a capacity larger than the capacity of the program area. A large amount of calculation is necessary for encryption and decryption processing of the resource area.

In view of this, as shown in the figure, in this embodiment, in a data area 46 of the application data, a program area 132, a header area 131, and a parity/electronic signature/additional information area 134 are encrypted by the AES or the like. However, a resource area 133 having a large capacity is provided without being encrypted.

However, the resource area 133 may be encrypted by the low-strength encryption system such as the XOR.

Such an encryption method is also encryption processing by the encryption systems having different strengths for each section, and hence can be considered as a kind of the mixed encryption processing discussed in the above-mentioned third embodiment. Thus, as in the above-mentioned third embodiment, in an area of part of an additional data area 43 according to this embodiment, mixed encryption version information 71 indicating a version of the mixed encryption processing is described.

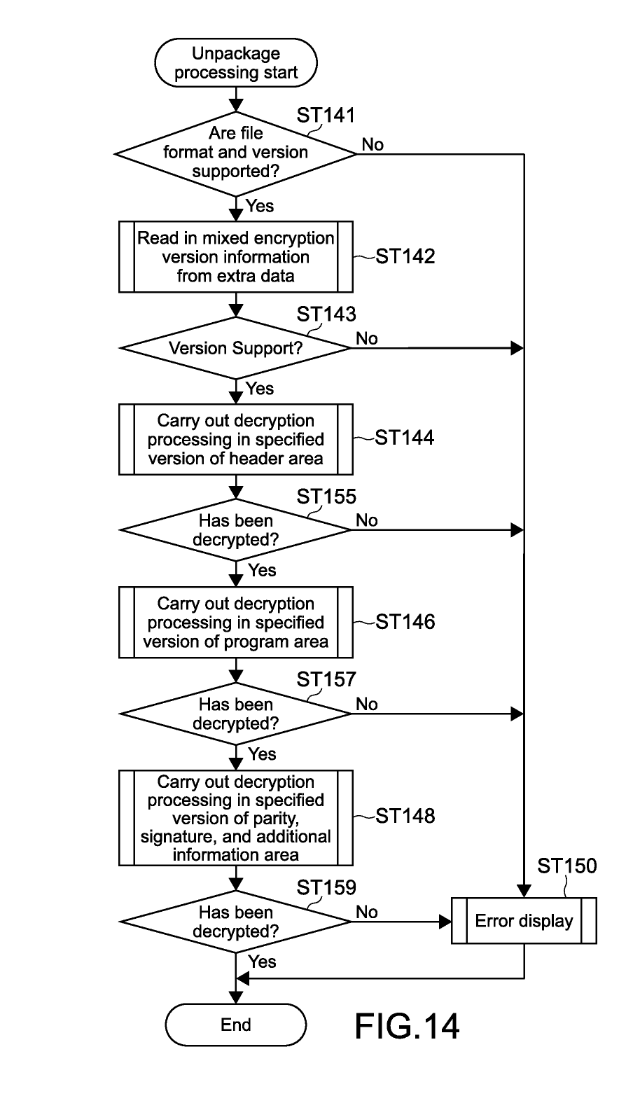

FIG. 14 is a flowchart showing a flow of decryption processing of application data by the CE device 100 according to this embodiment.

As shown in the figure, first, a downloader of the CE device 100 downloads the application data as in the above-mentioned first to fifth embodiments, and an unpackager determines whether or not the application data can be installed based on a file name thereof (Step 141).

Subsequently, the unpackager reads in the mixed encryption version information 71 from the additional data area 43 (Step 142).

Subsequently, based on the mixed encryption version information 71, the unpackager determines whether or not the unpackager itself accommodates mixed-encryption decryption processing in a specified version described in the mixed encryption version information 71 (Step 143).

If the unpackager determines that the unpackager itself accommodates the mixed-encryption decryption processing in such a version (Yes), the unpackager first decrypts the header area of the data area 46 by the decryption system in that specified version (Step 144).

Subsequently, the unpackager decrypts the program area of the data area 46 by the decryption system in the above-mentioned specified version (Step 146).

Subsequently, the unpackager decrypts the parity/electronic signature/additional information area of the data area 46 by the decryption system in the specified version (Step 148).

If the unpackager determines that the unpackager itself does not accommodate the mixed-encryption decryption processing in the above-mentioned version (No in Step 143) or if any area of the data area 46 has not been correctly decrypted (No in Steps 155, 157, and 159), the unpackager displays an error on a display unit 16 and terminates the processing (Step 150).

As discussed above, according to this embodiment, the resource area having a large capacity out of the application data is unencrypted, and hence the CE device 100 is able to further reduce the time taken for the decryption processing.

### Seventh Embodiment

Next, a seventh embodiment of the present disclosure will be described.

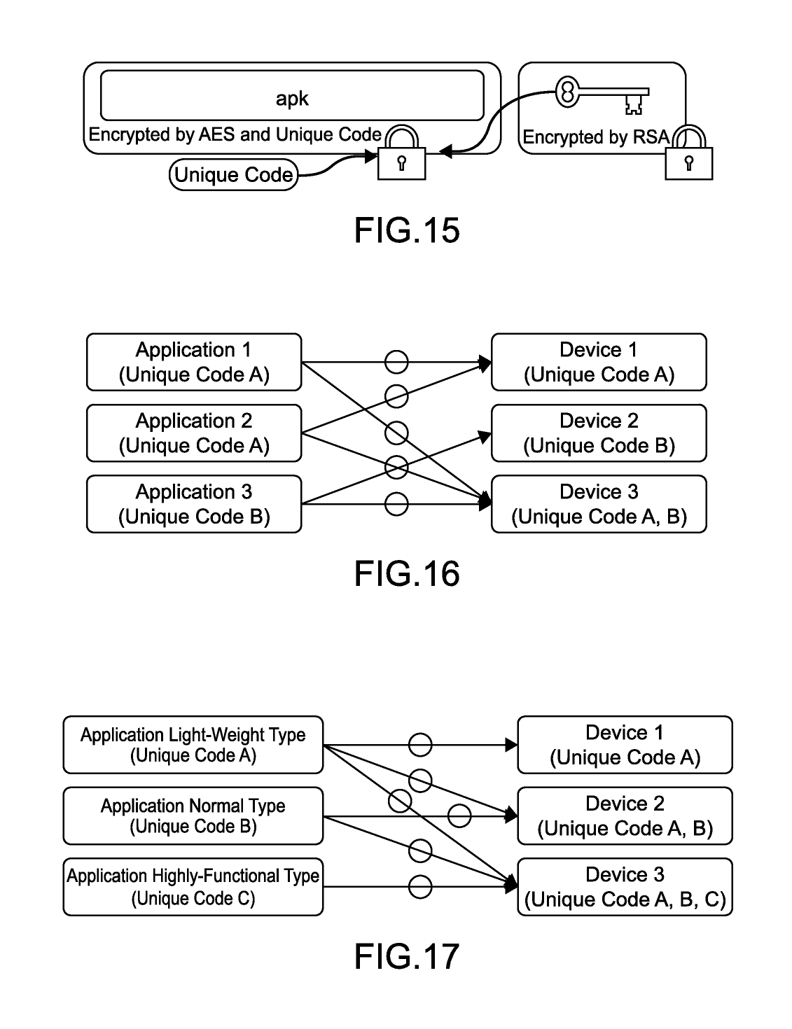

FIG. 15 is a view showing an encryption system of application data that can be installed into a CE device 100 out of application data provided by a server 200 according to this embodiment.

As shown in the figure, in this embodiment, unlike the method discussed above with reference to the first embodiment, an apk file of original application data is encrypted with a value obtained by performing exclusive-OR (EXOR) calculation of a common key of the AES encryption system and a unique code externally supplied as an argument.

Here, the unique code means identification information corresponding to a kind or a specification (version) of the CE device 100. For example, if different kinds of CE devices 100, for example, a digital still camera and a BD recorder are used, different unique codes may be assigned. Further, for example, out of digital still cameras, different unique codes may be assigned to a single-lens reflex camera and a different camera. The unique code is stored in a ROM 12 or a storage unit 18 of each CE device 100. Each CE device 100 stores at least one unique code.

Further, the common key used in the above-mentioned AES encryption is encrypted with the secret key of the RSA as in the above-mentioned embodiments, and is packaged as a file having a predetermined extension such as “pkg” together with the apk file encrypted with the common key of the AES and the unique code.

Using this unique code in encryption of the application data, a developer can provide the application data depending on the kind or the specification of the CE device 100. FIGS. 16 and 17 are views each showing an example of providing the application data depending on the kind or the specification of the CE device 100.

As shown in FIG. 16, depending on the unique code incorporated in the CE device 100, an application that can be installed may be set. In the example of FIG. 16, applications 1 and 2 are each encrypted with an identical unique code A and CE devices 1 and 3 each include the unique code A, and hence the CE devices 1 and 3 are able to install the applications 1 and 2. Further, the CE device 3 includes two unique codes A and B, and hence is able to install also applications (1 to 3) encrypted with either of the two unique codes A and B.

As shown in FIG. 17, a plurality of applications having different realizable functions, and applications that can be installed into the CE device 100 depending on performance of the CE device 100 may be set. In this case, the application data is encrypted with a unique code different depending on the level of the function while the CE device 100 includes a different number of unique codes depending on performance thereof.

For example, the CE device 1 has relatively low performance, and hence includes a minimum unique code A. The CE device 2 has average performance, and hence includes the unique code B in addition to the unique code A. The CE device 3 has high performance, and hence includes a unique code C in addition to the unique codes A and B.

In this case, a lightweight application (e.g., small number of pixels or limited functions of resource) is encrypted with the unique code A. A normal application is encrypted with the unique code B. A highly-functional application (large number of pixels and multiple functions) is encrypted with the unique code C.

With this, the CE device 3 having high performance is able to install applications in all the above-mentioned versions. Meanwhile, the CE device 1 having low performance is able to install only lightweight applications.

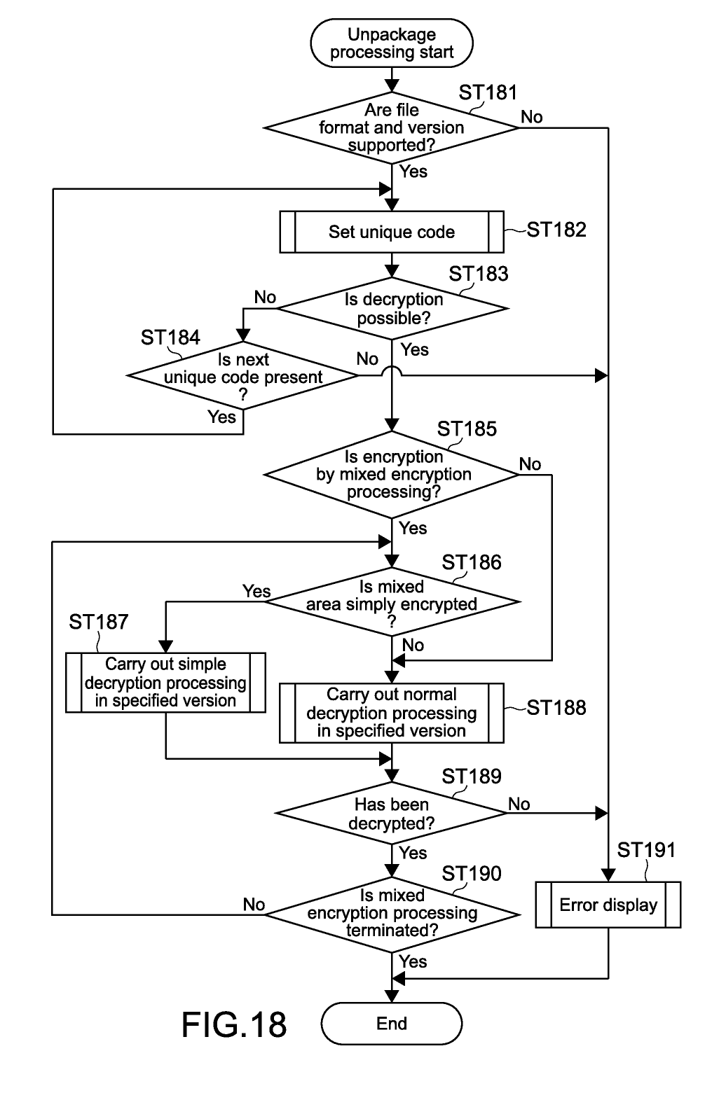

FIG. 18 is a flowchart showing a flow of decryption processing of application data by the CE device 100 according to this embodiment.

As shown in the figure, first, a downloader of the CE device 100 downloads the application data as in the above-mentioned first to sixth embodiments, and an unpackager determines whether or not the application data can be installed based on a file name thereof (Step 181).

Subsequently, the unpackager sets a unique code used in the decryption processing (Step 182). If the CE device 100 includes only one unique code, this unique code is automatically set.

Subsequently, the unpackager determines whether or not application data can be decrypted using the set unique code, and specifically, whether or not the unique code used in the application data and the set unique code are identical (Step 183).

If the unpackager determines that the application data cannot be decrypted with the set unique code (No), the unpackager determines whether or not a subsequent unique code is present (Step 184). If so (Yes), the unpackager sets the unique code (Step 182). The unpackager repeats such setting processing of the unique code until a unique code able to decrypt the application data is found.

If the unpackager determines that the application data can be decrypted with the set unique code (Yes in Step 183), the unpackager determines whether or not the application data is encrypted by the mixed encryption processing (Step 185).

If the unpackager determines that the application data is not encrypted by the mixed encryption processing (No), the unpackager decrypts the application data by a decryption system in a version specified by the above-mentioned additional data area 43 (Step 188).

If the unpackager determines that the application data is encrypted by the mixed encryption processing (Yes in Step 185), the unpackager refers to a first encrypted section and determines whether or not that section is encrypted by a simple encryption system (low-strength encryption system) (Step 186).

If the unpackager determines that that section is encrypted by the simple encryption system (Yes), the unpackager decrypts the section by a simple decryption system in a version corresponding thereto (Step 187).

Meanwhile, if the section is not encrypted by the simple encryption system (No in Step 186), the unpackager decrypts the section by a normal (not simple) decryption system in a version corresponding thereto (Step 188).

The unpackager repeats the processing in the Steps 186 to 188 until the decryption processing of all the sections encrypted by the mixed encryption processing is completed (Step 190).

If the unpackager determines in the Step 184 that the unique code that can be set is not present or if the application data (or each section) has not been correctly decrypted (No in Step 189), the unpackager displays an error on the display unit 16 and terminates the processing (Step 191).

As discussed above, according to this embodiment, the unique code is used in encryption of the application data. With this, it becomes possible to provide the application data depending on the application functions and the performance of the CE device 100.

Further, the common key of the apk file encrypted by the AES encryption system can be varied depending on the unique code, and hence it is more likely to prevent illegal install processing. In addition, even if the identical unique codes are assigned to the same kind of CE devices 100 or the CE devices 100 having the same specification, and the application data is leaked to the outside by, for example, hacking of the CE device 100, a different kind of CE device or a CE device having a different specification is not able to decrypt the application data, which minimizes the damage due to the leaking.

### MODIFIED EXAMPLES

The present disclosure is not limited to the above-mentioned embodiments and may be variously changed without departing from the gist of the present disclosure.

### Modified Example 1

Although, in the above-mentioned embodiments, the application data is encrypted, the application data may be unencrypted as long as the application data is encoded by a reversible algorithm. For example, the application data may be compressed by a predetermined compression technology.

### Modified Example 2

The above-mentioned first to seventh embodiments may be implemented in any combination without causing contractions.

### Modified Example 3

The encryption system for application data in the present disclosure is not limited to that shown in each of the above-mentioned first to seventh embodiments, and various other encryption systems may be freely combined. Further, the file format of the application data is not also limited to that described in each of the above-mentioned embodiments.

### Modified Example 4

In the above-mentioned seventh embodiment, the unique code is stored in the ROM 12, the storage unit 18, or the like of each CE device 100, read out therefrom, and used for the decryption processing. However, the unique code may be stored in the server 200 that provides the applications or a different server. Then, the CE device 100 may download the unique code of the CE device 100 by performing authentication with the server using a specific ID such as a product name and a product number described in the additional data area 43. Further, the downloaded unique code may be stored in the storage unit 18 or the like or may be updated by communication with the server after that.

### Modified Example 5

In each of the above-mentioned third to sixth embodiments, the example in which the data area 46 of the application is subjected to the mixed encryption processing by the encryption systems having different strengths has been shown. As this mixed encryption processing, various forms other than those described above will be assumed. For example, if the application data has a directory structure, a specification of the mixed encryption processing (data length of each section to be encrypted, number of sections, encryption system applied to each section, or the like) may be different for each folder of the directory.

### Modified Example 6

In FIG. 1 in the above-mentioned first embodiment, the example in which the server 200 that provides the applications is provided on the Internet has been shown. However, the server that provides the applications may be provided on a home network (LAN) constituted of the CE devices 100. Further, without the provision of the server for providing the applications, one of the plurality of CE devices on the home network may function as the server, for example. Specifically, software that controls the CE device (server CE device) that functions as the server may be included in another CE device (control CE device), and the control CE device may download applications from the server CE device by the user operating the control CE device.

### [Others]

It should be noted that the present disclosure may also take the following configurations.

(1) An information processing apparatus, including:

a communication unit configured to be able to download arbitrary application data from a service on a network in which first application data encoded by a predetermined system and second application data encoded by another system or unencoded;

a storage unit configured to store decoding information for decoding the first application data; and

a controller configured to be able to decode the first application data using the decoding information to install a first application obtained by decoding the first application data.

(2) The information processing apparatus according to Item (1), in which

the first application data includes a file name including a predetermined extension,

the storage unit is configured to store extension information indicating the predetermined extension, and

the controller is configured to compare the extension information with an extension of the downloaded application data before the decoding to determine whether or not the application data can be installed.

(3) The information processing apparatus according to Item (1) or (2), in which

the first application data includes
a first section encrypted by a first encryption system, and
a second section encrypted by a second encryption system different from the first encryption system or unencrypted,

the storage unit is configured to store, as the decoding information, a first decryption key corresponding to the first encryption system and a second decryption key corresponding to the second encryption system, and

the controller is configured to be able to decrypt the encrypted first section with the first decryption key, and to decrypt the encrypted second section with the second decryption key.

(4) The information processing apparatus according to Item (3), in which

the second encryption system has strength lower than strength of the first encryption system.

(5) The information processing apparatus according to Item (3) or (4), in which

the first section is a program area, and

the second section is a resource area.

(6) The information processing apparatus according to any one of Items (3) to (5), in which

the first application data includes an additional data area in which structure information indicating a structure of the first section and a structure of the second section is described, and

the controller is configured to be able to decrypt the first section and the second section based on the structure information.

(7) The information processing apparatus according to any one of Items (1) to (6), in which

the first application data includes an additional data area in which specification information indicating a specification of the first application data is described, and

the controller is configured to be able to determine whether or not the first application data can be installed based on the specification information described in the additional data area before the decoding.

(8) The information processing apparatus according to any one of Items (1) to (7), in which

the first application data is obtained by encoding application data in different versions depending on a specification of the information processing apparatus into single data, and includes an additional data area in which specification information is described, the specification information indicating a relationship between the specification of the information processing apparatus and a version of application data that can be installed, and

the controller is configured to be able to select, before the decoding, based on the specification information described in the additional data area, application data to be installed from the application data in different versions.

(9) The information processing apparatus according to any one of Items (1) to (8), in which

the first application data includes an additional data area in which determination information for determining whether or not the first application data is correctly decoded is described, and

the controller is configured to be able to determine, after the decoding of the first application data and before the installation, based on the determination information described in the additional data area, whether or not the first application data is correctly decoded.

(10) The information processing apparatus according to any one of Items (1) to (9), in which

the first application data is encrypted with a predetermined encryption key and a unique code that depends on one of a kind and a specification of the information processing apparatus,

the storage unit is configured to store the encryption key and the unique code that depends on the one of the kind and the specification of the information processing apparatus, and

the controller is configured to be able to decode the first application data using the stored encryption key and unique code.

(11) The information processing apparatus according to any one of claims (1) to (10), including an apparatus other than a smart phone.
(12) The information processing apparatus according to any one of Items (1) to (11), including a camera.

The present disclosure contains subject matter related to that disclosed in Japanese Priority Patent Application JP 2012-190200 filed in the Japan Patent Office on Aug. 30, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a communication unit configured to be able to download, from a service on a network in which first application data encoded by a predetermined system and second application data encoded by another system or unencoded are both provided, arbitrary application data;
a storage unit configured to store decoding information for decoding the first application data; and
a controller configured to be able to decode the first application data using the decoding information to install a first application obtained by decoding the first application data.

2. The information processing apparatus according to claim 1, wherein
the first application data includes a file name including a predetermined extension,
the storage unit is configured to store extension information indicating the predetermined extension, and
the controller is configured to compare the extension information with an extension of the downloaded application data before the decoding to determine whether or not the application data can be installed.

3. The information processing apparatus according to claim 1, wherein
the first application data includes
a first section encrypted by a first encryption system, and
a second section encrypted by a second encryption system different from the first encryption system or unencrypted,
the storage unit is configured to store, as the decoding information, a first decryption key corresponding to the first encryption system and a second decryption key corresponding to the second encryption system, and
the controller is configured to be able to decrypt the encrypted first section with the first decryption key, and to decrypt the encrypted second section with the second decryption key.

4. The information processing apparatus according to claim 3, wherein
the second encryption system has strength lower than strength of the first encryption system.

5. The information processing apparatus according to claim 4, wherein
the first section is a program area, and
the second section is a resource area.

6. The information processing apparatus according to claim 4, wherein
the first application data includes an additional data area in which structure information showing a structure of the first section and a structure of the second section is described, and
the controller is configured to be able to decrypt the first section and the second section based on the structure information.

7. The information processing apparatus according to claim 1, wherein
the first application data includes an additional data area in which specification information indicating a specification of the first application data is described, and
the controller is configured to be able to determine whether or not the first application data can be installed based on the specification information described in the additional data area before the decoding.

8. The information processing apparatus according to claim 1, wherein
the first application data is obtained by encoding application data in different versions depending on a specification of the information processing apparatus into single data, and includes an additional data area in which specification information is described, the specification information indicating a relationship between the specification of the information processing apparatus and a version of application data that can be installed, and
the controller is configured to be able to select, before the decoding, based on the specification information described in the additional data area, application data to be installed from the application data in different versions.

9. The information processing apparatus according to claim 1, wherein
the first application data includes an additional data area in which determination information for determining whether or not the first application data is correctly decoded is described, and
the controller is configured to be able to determine, after the decoding of the first application data and before the installation, based on the determination information described in the additional data area, whether or not the first application data is correctly decoded.

10. The information processing apparatus according to claim 1, wherein
the first application data is encrypted with a predetermined encryption key and a unique code that depends on one of a kind and a specification of the information processing apparatus,
the storage unit is configured to store the encryption key and the unique code that depends on the one of the kind and the specification of the information processing apparatus, and
the controller is configured to be able to decode the first application data using the stored encryption key and unique code.

11. The information processing apparatus according to claim 1, comprising an apparatus other than a smart phone.

12. The information processing apparatus according to claim 1, comprising a camera.

13. An information processing method, comprising:
downloading, from a service on a network in which first application data encoded by a predetermined system and second application data encoded by another system or unencoded are both provided, the first application data;
decoding the first application data using the decoding information for decoding the first application data; and
installing a first application obtained by decoding the first application data.

14. A program that causes an information processing apparatus to execute the steps of;
downloading, from a service on a network in which first application data encoded by a predetermined system and second application data encoded by another system or unencoded are both provided, the first application data;
decoding the first application data using the decoding information for decoding the first application data; and
installing a first application obtained by decoding the first application data.
